(19) United States
(12) Patent Application Publication
(10) Pub. No.: US 2013/0136438 A1
(43) Pub. Date: May 30, 2013

(54) VOICE COIL MOTOR AND DRIVING MEHOD THEREOF

(71) Applicant: LG INNOTEK CO., LTD., Seoul (KR)

(72) Inventors: Seong Min LEE, Seoul (KR); Sang Ok PARK, Seoul (KR)

(73) Assignee: LG INNOTEK CO., LTD., Seoul (KR)

(21) Appl. No.: 13/686,709

(22) Filed: Nov. 27, 2012

(30) Foreign Application Priority Data
Nov. 30, 2011 (KR) 10-2011-0126641

(51) Int. Cl. G03B 3/10; G02B 7/02

(52) U.S. Cl. CPC G03B 3/10; G02B 7/023
USPC 396/133; 359/811

(57) ABSTRACT

A VCM is disclosed, the VCM including a stator including a first driving unit fixed to a base to generate a first magnetic field, a rotor including a bobbin mounted with a lens to vertically move relative to the base and a second driving unit generating a second magnetic field reacting to the first magnetic field, an elastic member connected to the stator and the rotor to elastically support the rotor, and a position sensor arranged to any one of the first and second driving units to sense a position of the rotor relative to the stator.

### CROSS-REFERENCE TO RELATED APPLICATION

This application claims the benefit under 35 U.S.C. §119 of Korean Patent Application No. 10-2011-0126641, filed Nov. 30, 2011, which is hereby incorporated by reference in its entirety.

### BACKGROUND OF THE INVENTION

1. Field of the Invention

The present disclosure relates to a VCM (Voice Coil Motor) and a driving method thereof.

2. Description of Related Art

Recently, a mobile phone mounted with a super small-sized digital camera has been developed. However, although the super small-sized digital camera applied to a conventional mobile phone suffers from disadvantages of disablement of adjustment of a gap between a lens and an image sensor converting outside light having passed the lens to a digital image or a digital video, a lens driving device such as a VCM (Voice Coil Motor) capable of adjusting a gap between the image sensor and the lens has been developed recently to enable obtainment of a much improved digital image or a digital video from the super small-sized digital camera.

Generally, a VCM is mounted therein with a lens, and a bobbin mounted at an upper surface of a base moves to an upper surface from the base to adjust a gap between a lens and an image sensor arranged at a rear surface of the base.

Furthermore, the VCM is coupled to a leaf spring, and in a case the VCM is not operated, the bobbin is always brought into contact with the base by elastic force of the leaf spring. That is, the bobbin in the conventional VCM is driven to one direction towards an upper surface relative to the base.

The VCM requires a driving force greater than a self-weight of the bobbin and the elastic force of the leaf spring in order to drive the VCM due to the driving of the VCM to one direction, whereby power consumption of the VCM has disadvantageously increased tremendously.

Furthermore, due to the fact that the VCM requires a driving force greater than a self-weight of the bobbin and the elastic force of the leaf spring in order to drive the VCM, size of a magnet or a coil wound on the bobbin increases to disadvantageously increase an entire size of the VCM. On top of these disadvantages, in a case the leaf spring is deformed, the lens and the image sensor are defocused to greatly reduce quality of an image.

Meanwhile, in a case the bobbin mounted with a lens in the VCM is distanced from the base to reduce the power consumption, position of the bobbin distanced from the base is changed to make it difficult to accurately and continuously adjust a focus between the lens and the image sensor, whereby an unnecessary power consumption is disadvantageously generated due to the changed position of the bobbin. Accordingly, there is room for improvement in the VCM.

### BRIEF SUMMARY

The present invention is directed to provide a VCM (Voice Coil Motor) configured to apply a driving signal to adjust a gap between a lens and an image sensor, while a rotor mounted with a lens is distanced from an upper surface of a base during no application of the driving signal, to enable a driving with a reduced power consumption, and to sense a position of the rotor for enablement of accurate and continuous focus adjustment, whereby unnecessary power consumption can be inhibited, and a driving method of the VCM.

Technical problems to be solved by the present disclosure are not restricted to the above-mentioned descriptions, and any other technical problems not mentioned so far will be clearly appreciated from the following description by skilled in the art.

An object of the invention is to solve at least one or more of the above problems and/or disadvantages in whole or in part and to provide at least the advantages described hereinafter. In order to achieve at least the above objects, in whole or in part, and in accordance with the purposes of the invention, as embodied and broadly described, and in one general aspect of the present invention, there is provided a VCM, the VCM comprising: a stator including a first driving unit fixed to a base to generate a first magnetic field; a rotor including a bobbin mounted with a lens to vertically move relative to the base and a second driving unit generating a second magnetic field reacting to the first magnetic field; an elastic member connected to the stator and the rotor to elastically support the rotor; and a position sensor arranged to any one of the first and second driving units to sense a position of the rotor relative to the stator.

In another general aspect of the present disclosure, there is provided a method for driving a VCM, the method comprising: applying, to a controller, a current position of a rotor vertically moving relative to a stator by sensing the current position of the rotor; determining, by the controller, the position of the rotor in response to a sensing signal generated from a position sensor; determining, by the controller, a level of the driving signal for adjusting a gap between the rotor and an image sensor opposite to the rotor based on the sensing signal; and adjusting the gap between the rotor and the image sensor by applying the driving signal to the rotor or the stator in response to the level of the driving signal.

The VCM according to the present disclosure has an advantageous effect in that a position sensor sensing a rotor deviation relative to a stator is mounted on at least one of a stator or a rotor operating to the stator to accurately determine a current position of the rotor, whereby a focusing function can be more quickly realized in response to the rotor operation, and consumption power can be reduced by removing an unnecessary driving range of the rotor.

### BRIEF DESCRIPTION OF THE DRAWINGS

In the drawings, the width, length, thickness, etc. of components may be exaggerated or reduced for the sake of convenience and clarity. Furthermore, throughout the descriptions, the same reference numerals will be assigned to the same elements in the explanations of the figures, and explanations that duplicate one another will be omitted. Now, a voice coil motor according to the present disclosure will be described in detail with reference to the accompanying drawings.

The teachings of the present disclosure can be readily understood by considering the following detailed description in conjunction with the accompanying drawings, in which:

FIG. 1 is a schematic conceptual view of a VCM according to an exemplary embodiment of the present disclosure;

FIG. 2 is a schematic conceptual view of a VCM according to another exemplary embodiment of the present disclosure;

FIG. 3 is a schematic conceptual view of a VCM according to still another exemplary embodiment of the present disclosure; and

FIG. 4 is a flowchart illustrating a method for driving a VCM according to an exemplary embodiment of the present disclosure.

### DETAILED DESCRIPTION

Advantages and features of the present disclosure may be understood more readily by reference to the following detailed description of exemplary embodiments and the accompanying drawings. Detailed descriptions of well-known functions, configurations or constructions are omitted for brevity and clarity so as not to obscure the description of the present disclosure with unnecessary detail. Thus, the present disclosure is not limited to the exemplary embodiments which will be described below, but may be implemented in other forms.

The meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

Now, exemplary embodiments of a VCM (Voice Coil Motor) and a method for driving the VCM according to the present disclosure will be described in detail together with the figures.

FIG. 1 is a schematic conceptual view of a VCM according to an exemplary embodiment of the present disclosure.

Referring to FIG. 1, a VCM (100) includes a base (110), a stator (120), a rotor (130), an elastic member (140) and a position sensor (150). The base (110) serves to support the stator (120) and the rotor (130). The base (110) is formed an opening passing through an upper surface and a bottom surface thereof, and the opening is formed at a position corresponding to that of a lens (132) of the rotor (130, described later). An image sensor (115) may be arranged at a rear surface of the base (110) for generating a digital image or a digital video corresponding to light incident through the opening.

The stator (120) is arranged on the base (110). The stator (120) is not driven. The stator (120) includes a first driving unit (125) for driving the rotor (130, described later), where the first driving unit (125) generates a first magnetic field. The first driving unit (125) in an exemplary embodiment of the present disclosure may include a plurality of magnets.

The rotor (130) is arranged inside the stator (120), and includes a lens (132), a bobbin (134) and a second driving unit (136). The bobbin (134) of the rotor (130) takes a shape of an upper and bottom opened cylinder, for example, and the lens (132) is coupled to an inner surface of the bobbin (134). The lens (132) may be coupled to the inner surface of the bobbin (134) using a screw connection method, for example.

The second driving unit (136) is arranged at an outer surface of the bobbin (134). The second driving unit (136) may include a coil block. The coil block is formed by winding an insulated wire or a coated long wire. The coil block is wound in a cylinder shape to be arranged at an outer surface of the bobbin (134), or directly wound to the outer surface of the bobbin (134).

The second driving unit including the coil block reacts to the first magnetic field in response to a driving signal including a current to generate a second magnetic field generating an attractive force or a repulsive force.

The elastic member (400) is coupled to the stator (120) and the rotor (130) to elastically support the rotor (130). The elastic member (400) in an exemplary embodiment of the present disclosure may include a leaf spring, for example, and may be coupled to an upper surface and a bottom surface of the bobbin (134) of the rotor (130).

The rotor (130) elastically coupled to the elastic member (400) in an exemplary embodiment of the present disclosure is spaced apart from the upper surface of the base (110) at a predetermined distance, in a case no driving signal is applied to the second driving unit (136) inclusive of the coil block.

In a case the rotor (130) is arranged at a position distanced from the upper surface of the base (110) while no driving signal is applied to the second driving unit (136), the rotor (130) is bi-directionally driven to a direction distancing from the upper surface of the base (110) or to a direction approaching the upper surface of the base (110) in response to a direction of a current which is a driving signal, whereby the VCM (100) can greatly reduce the power consumption at a low current operation.

Meanwhile, in a case the rotor (130) is floated from the upper surface of the base (110) while no driving signal is applied to the second driving unit (136), it is difficult for a controller to determine a reference position or a current position of the rotor (130), whereby unnecessary power consumption may be generated due to the rotor (130) being unnecessarily or inaccurately driven.

In an exemplary embodiment of the present invention, a position sensor (150) is arranged on the second driving unit (136) opposite to the first driving unit (125) including the magnet to allow the controller to determine the current position of the rotor (130).

The position sensor (150) outputs a sensing signal to the controller (not shown) relative to the reference position and/or the current position of the rotor (130), where the controller provides a driving signal to the second driving unit (136) including a coil block in response to the sensing signal outputted from the position sensor (150).

In an exemplary embodiment of the present disclosure, the position sensor (150) includes a Hall sensor which is one of magnetic sensors adequate to sense a position of the rotor (130) in response to changes in magnetic field, and a wire applying a driving power and outputting a sensing signal by being connected to the Hall sensor, where the wire may be electrically connected to a circuit board arranged at a rear surface of the base (110) for generating a driving signal. One position sensor (150) may be arranged to the second driving unit (136) in consideration of manufacturing cost. Alternatively, a plurality of position sensors, each spaced apart at an equidistant gap, may be arranged to the second driving unit (136).

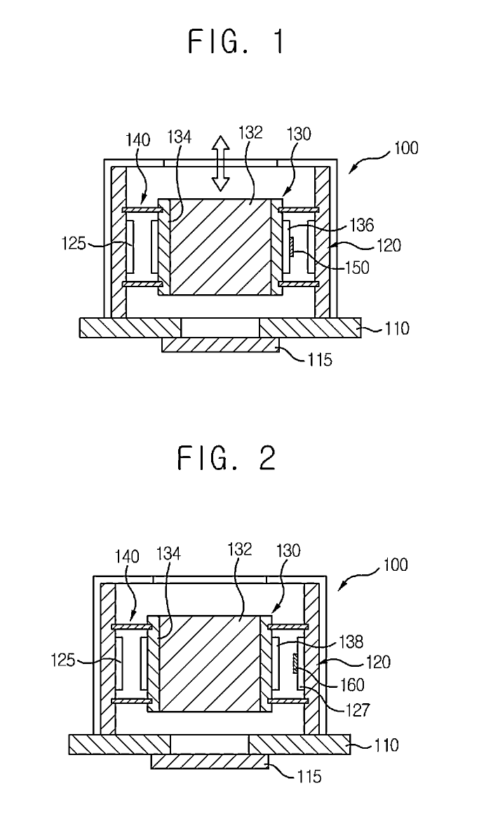

FIG. 2 is a schematic conceptual view of a VCM according to another exemplary embodiment of the present disclosure.

The VCM according to another exemplary embodiment of the present disclosure has a substantially same configuration as that of FIG. 1 except for arrangement of first and second driving units and the position sensor. The redundant explanation and description of the same configuration are omitted. Thus, the same reference numerals will be assigned to the same elements in the explanations of the figures.

Referring to FIG. 2, a VCM (100) includes a base (110), a stator (120), a rotor (130), an elastic member (140) and a position sensor (160). The stator (120) includes a first driving unit (127) for generating a first magnetic field. The first driving unit (127) in an exemplary embodiment of the present disclosure may include a coil block formed in a shape of a cylinder by winding a long wire insulated by insulation resin.

A second driving unit (138) may be arranged at an outer surface of the bobbin (134) of the rotor (130) arranged inside the stator (120) to generate an attractive force or a repulsive force in response to a first magnetic field.

In an exemplary embodiment of the present disclosure, the second driving unit (138) opposite to the first driving unit (127) including the coil block may include a plurality of magnets.

The position sensor (160) may be a Hall sensor, for example, and may be arranged at an inner surface of the first driving unit (127) including the coil block opposite to the second driving unit (138). The position sensor (160) outputs a sensing signal in response to a current position of the rotor (130) by sensing changes in a second magnetic field generated by the second driving unit (138) in response to movement of the rotor (130). The position sensor (160) outputs a sensing signal to a controller (not shown) in response to a reference position and/or a current position of the rotor (130), where the controller provides an adequate driving signal to the first driving unit (127) including the coil block in response to the sensing signal outputted from the position sensor (160).

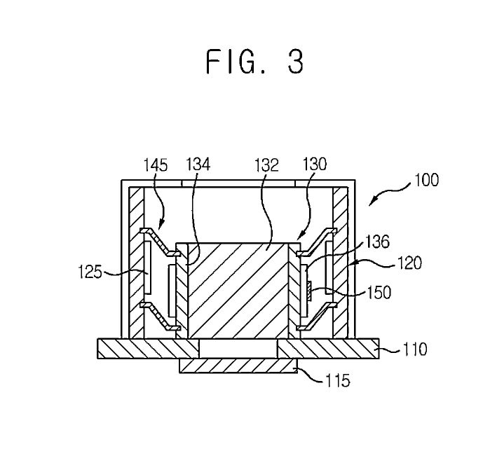

FIG. 3 is a schematic conceptual view of a VCM according to still another exemplary embodiment of the present disclosure.

The VCM according to still another exemplary embodiment of the present disclosure has a substantially same configuration as that of FIG. 2 except for arrangement of elastic member and rotor. The redundant explanation and description of the same configuration are omitted.

Thus, the same reference numerals will be assigned to the same elements in the explanations of the figures.

Referring to FIG. 3, a VCM (100) includes a base (110), a stator (120), a rotor (130), an elastic member (140) and a position sensor (150). The stator (120) includes a first driving unit (125), where the first driving unit (125) includes at least one magnet for generating a first magnetic field.

The rotor (130) is arranged inside the stator (120), and includes a second driving unit (136) opposite to the first driving unit (125), where the second driving unit (136) may include a coil block formed by winding an insulated long wire. The second driving unit (136) generates a second magnetic field generating an attractive force or a repulsive force in interaction with the first magnetic field.

The elastic member (400) is elastically coupled to the stator (120) and the rotor (130). The rotor (130) elastically coupled to the elastic member (400) in an exemplary embodiment of the present disclosure is brought into contact with an upper surface of the base (110), in a case no driving signal is applied to the second driving unit (136), and is spaced apart from the upper surface of the base (110), in a case a driving signal is applied to the second driving unit (136).

The position sensor (150) is arranged on the second driving unit (136), and outputs a sensing signal by sensing changes in magnetic fields as the rotor (130) is distanced from the upper surface of the base (110).

The position sensor (150) outputs a sensing signal to the controller (not shown) relative to the reference position and/or the current position of the rotor (130), where the controller provides an adequate driving signal to the second driving unit (136) including a coil block in response to the sensing signal outputted from the position sensor (150).

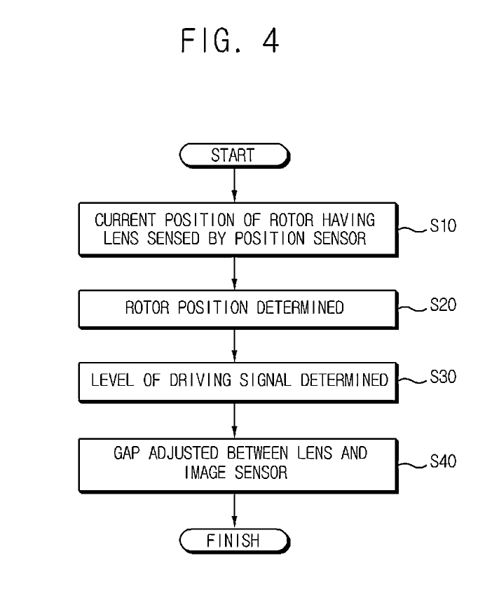

FIG. 4 is a flowchart illustrating a method for driving a VCM (100) according to an exemplary embodiment of the present disclosure.

Referring to FIGS. 1 and 4, in order to drive the VCM (100), a step is first performed to sense a reference position or a current position of a rotor (130) having a lens (132) through a position sensor (150) (S10). To be more specific, the position sensor (150) is arranged on the base (110) to be arranged to any one of the stator (120) having the first driving unit (125) and the rotor (130) vertically moving relative to the stator (120) and having the second driving unit (136).

In a non-limiting example, in a case the first driving unit (125) includes a magnet, and the second driving unit (136) includes a coil block, the position sensor (150) such as a Hall sensor is arranged on the second driving unit (136) opposite to the first driving unit (125). Alternatively, in a case the first driving unit (125) includes a coil block, and the second driving unit (136) includes a magnet, the position sensor (150) is arranged on the first driving unit (125) opposite to the second driving unit (136).

In a case the first and second driving units (125, 136) are not applied with the driving signal, the rotor (130) may be in a state of being distanced from the upper surface of the base (110) and being floated. Alternatively, in a case the first and second driving units (125, 136) are not applied with the driving signal, the rotor (130) may be in a state of being arranged to the upper surface of the base (110).

Successively, the sensing signal generated by the position sensor (150) is applied to a controller, where the controller determines a current position of the rotor (130) in response to the sensing signal generated by the position sensor (150) (S20). Then, the controller determines a level of the driving signal for adjusting a gap between the lens included in the rotor (130) and an image sensor based on the sensing signal generated by the position sensor (150) (S30).

Thereafter, the controller applies a driving signal to any one of the first and second driving units (125, 136) to adjust a gap between the lens and the image sensor (S40).

As apparent from the foregoing description, the present disclosure has an advantageous effect in that a position sensor sensing a rotor deviation relative to a stator is mounted on at least one of a stator or a rotor operating to the stator to accurately determine a current position of the rotor, whereby a focusing function can be more quickly realized in response to the rotor operation, and consumption power can be reduced by removing an unnecessary driving range of the rotor.

The present disclosure may, however, be embodied in many different forms and should not be construed as limited to the embodiment set forth herein. Thus, it is intended that embodiment of the present disclosure may cover the modifications and variations of this disclosure provided they come within the scope of the appended claims and their equivalents.

While particular features or aspects may have been disclosed with respect to several embodiments, such features or aspects may be selectively combined with one or more other features and/or aspects of other embodiments as may be desired.

What is claimed is:

1. A VCM, the VCM comprising: a stator including a first driving unit fixed to a base to generate a first magnetic field; a rotor including a bobbin mounted with a lens to vertically move relative to the base and a second driving unit generating a second magnetic field reacting to the first magnetic field; an elastic member connected to the stator and the rotor to elastically support the rotor; and a position sensor arranged to any one of the first and second driving units to sense a position of the rotor relative to the stator.

2. The VCM of claim 1, wherein the position sensor including a Hall sensor sensing the position of the rotor by using changes in magnetic field.

3. The VCM of claim 1, wherein the first driving unit includes at least one magnet, and the second driving unit includes a coil block formed by winding an insulated wire on the bobbin.

4. The VCM of claim 3, wherein the position sensor is arranged on the second driving unit opposite to the first driving unit.

5. The VCM of claim 1, wherein the first driving unit includes a coil block formed by winding an insulated wire on the bobbin, and the second driving unit includes a magnet.

6. The VCM of claim 5, wherein the position sensor is arranged on the first driving unit.

7. The VCM of claim 1, wherein the elastic member is formed in a pair, and includes a first elastic member arranged at a bottom surface of the bobbin, and a second elastic member arranged at an upper surface of the bobbin opposite to the bottom surface of the bobbin.

8. The VCM of claim 1, wherein the rotor is distanced from the upper surface of the bobbin, in a case the driving signal is not applied to the first and second driving units.

9. The VCM of claim 1, wherein the rotor is arranged at an upper surface of a base, in a case the driving signal is not applied to the first and second driving units.

10. The VCM of claim 1, wherein the position sensor includes a wire outputting a sensed signal, and wherein the wire is electrically connected to a circuit board arranged at a rear surface of the base.

11. A driving method of a VCM, the method comprising:
applying, to a controller, a current position of a rotor vertically moving relative to a stator by sensing the current position of the rotor;
determining, by the controller, the position of the rotor in response to a sensing signal generated from a position sensor;
determining, by the controller, a level of the driving signal for adjusting a gap between the rotor and an image sensor opposite to the rotor based on the sensing signal; and
adjusting the gap between the rotor and the image sensor by applying the driving signal to the rotor or to the stator in response to the level of the driving signal.

12. The method of claim 11, wherein the stator is arranged at an upper surface of a base to include a first driving unit, and the rotor includes a second driving unit.

13. The method of claim 12, wherein the rotor is distanced from the upper surface of the base to float, in a case the first and second driving units are not applied with the driving signal.

14. The method of claim 12, wherein the rotor is brought into contact with the upper surface of the base, in a case the first and second driving units are not applied with the driving signal.

15. The method of claim 12, wherein the position sensor is arranged on any one of the first and second driving units, and includes a Hall sensor generating a sensing signal in response to position change in the rotor.

16. The method of claim 15, wherein the Hall sensor is arranged on the first driving unit.

17. The method of claim 15, wherein the Hall sensor is arranged on the second driving unit.

18. The method of claim 12, wherein the first driving unit includes a magnet, and the second driving unit includes a coil block.

19. The method of claim 12, wherein the first driving unit includes a coil block, and the second driving unit includes a magnet.
